(19) United States
(12) Patent Application Publication
(10) Pub. No.: US 2013/0343045 A1
(43) Pub. Date: Dec. 26, 2013

(54) LED Light Module

(71) Applicants: Pervaiz Lodhie, Rolling Hills, CA (US); Bruce Johnson, Torrance, CA (US)

(72) Inventors: Pervaiz Lodhie, Rolling Hills, CA (US); Bruce Johnson, Torrance, CA (US)

(21) Appl. No.: 13/530,601

(22) Filed: Jun. 22, 2012

(51) Int. Cl. F21V 5/04; F21L 4/02; F21V 29/00; F21V 21/00

(52) U.S. Cl. 362/184; 362/249.02; 362/235

(57) ABSTRACT

A Light Emitting Diode (LED) light module comprising three printed circuit boards (PCBs) positioned relative to each other; and a plurality of LED bulbs mounted on each of the three printed circuit boards with light collimating lenses to form a single light source.

### FIELD

The present disclosure relates generally to lighting sources. More particularly, the disclosure relates to a Light-Emitting Diode (“LED”) lighting source.

### BACKGROUND

LED bulbs are light sources that use semiconductor materials rather than filaments to emit light. LED bulbs are generally more efficient light sources than incandescent light bulbs because LED bulbs are nearly monochromatic and emit light within a very narrow range of wavelengths. LED bulbs also generally last many times longer than incandescent light bulbs.

Street light posts can be fitted with light sources to illuminate a street, parking lot, walkway, a building, etc. Historically, incandescent lights with filament type bulbs have been used for illumination. Since incandescent light bulbs illuminate radially outward, the illumination is distributed approximately uniformly in all directions. Additionally, incandescent lights typically have shortened life-spans than light modules using LED bulbs. Incandescent lights are typically less energy efficient than light modules using LED bulbs.

### SUMMARY OF THE DISCLOSURE

According to one aspect, a Light-Emitting Diode (“LED”) light module comprising three printed circuit boards (PCBs) positioned relative to each other; and a plurality of LED bulbs mounted on each of the three printed circuit boards to form a single light source. In one example, the three printed circuit boards are coupled to one or more light collimating lenses.

Advantages of the present disclosure may include minimizing or limiting light pollution above a horizontal line of the LED light module, focusing a light beam pattern to a particular area, and/or directing light illumination in a particular direction.

It is understood that other embodiments will become readily apparent to those skilled in the art from the following detailed description, wherein it is shown and described various embodiments by way of illustration. The drawings and detailed description are to be regarded as illustrative in nature and not as restrictive.

### BRIEF DESCRIPTION OF THE DRAWINGS

FIG. 1 illustrates a bottom view of an example of a LED light module within a housing.

FIG. 2 illustrates an example of an application for the LED light module.

FIG. 3 illustrates an example of the three printed circuit boards and their mounting structure.

FIG. 4 is a top view of the three printed circuit boards of FIG. 3, that is, from the view point of line kk as drawn in FIG. 3.

FIG. 5 illustrates a side view of the three printed circuit boards of FIG. 3, that is, from the view point of line mm as drawn in FIG. 3.

FIG. 6 illustrates a top view of the example LED light module within the housing shown in FIG. 1.

FIG. 7 illustrates a side view of the housing shown in FIG. 1 for the LED light module.

FIG. 8 illustrates a bottom view of the housing shown in FIG. 1 for the LED light module.

FIG. 9 illustrates a perspective view of a top side of a second example housing for housing a LED light module.

FIG. 10 illustrates a side view of the top side shown in FIG. 9.

FIG. 11 illustrates a bottom view of the top side shown in FIG. 9.

FIG. 12 illustrates a perspective view of a top side of a third example housing for housing a LED light module.

### DETAILED DESCRIPTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention. Acronyms and other descriptive terminology may be used merely for convenience and clarity and are not intended to limit the scope of the invention.

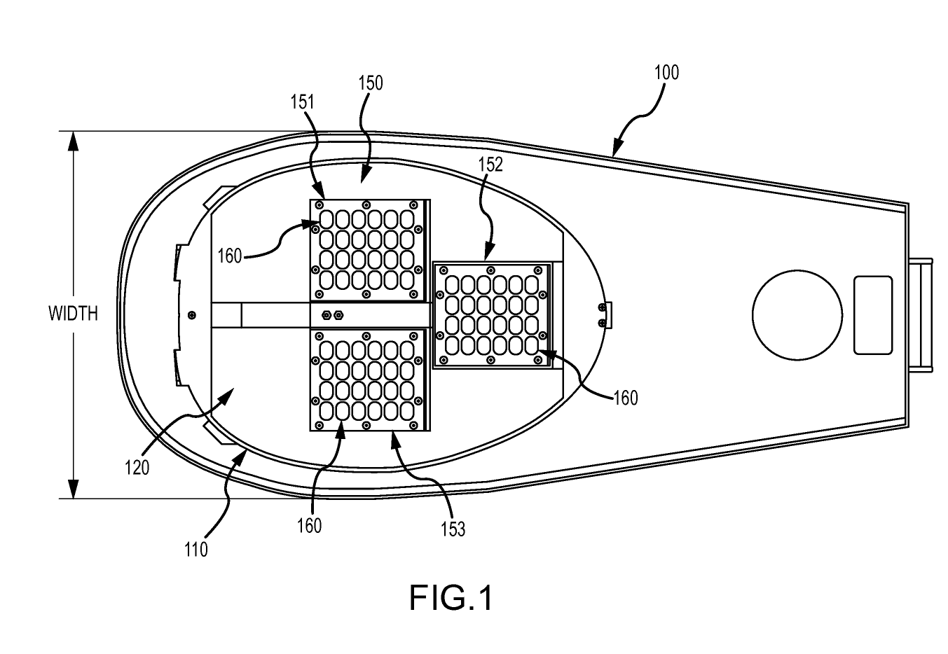

FIG. 1 illustrates a bottom view of an example of a LED light module 150 within a housing 100. In the example illustrated, the LED light module 150 includes three printed circuit boards and their associated lenses, (PCBs) 151, 152 and 153, each of the PCBs is populated with a plurality of LED bulbs 160. The housing 100 also includes a window opening 110. A window 120 is fitted over the window opening to allow light from the LED bulbs to shine through. In one example, the window 120 is an optical lens. In one example, the lens 120 is an aspheric window. In one example, the window 120 is made of one of the following materials: glass, polycarbonate material or plastic. In one aspect, the placement of the LED bulbs 160 are recessed from the window opening 110 so as to minimize light pollution above the horizontal plane defined by the window opening 110.

One skilled in the art would understand that an LED light module may have different percentages of its printed circuit boards populated with LED bulbs dependent on the desired illumination and other design considerations. Illumination distribution may depend on one or more of the following criteria: quantity of LED bulbs, power rating of the LED bulbs, distribution of the LED bulbs on the printed circuit board, the angles of the printed circuit board relative to one another, the angle of the LED light module, etc. One skilled in the art would recognize that the criteria listed herein are not exclusive and that other criteria not listed may impact illumination distribution.

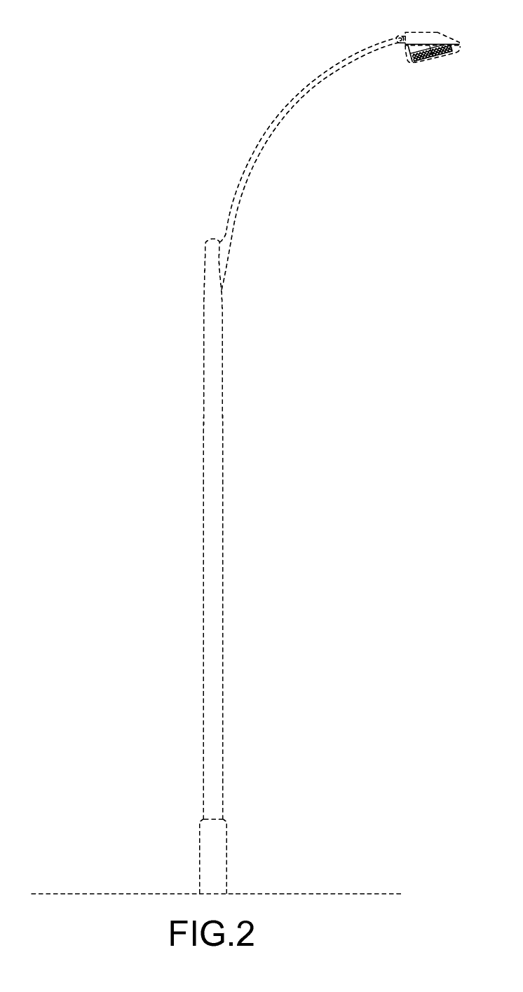

In one aspect, one or more of the printed circuit boards 151, 152, 153 is populated with a homogenous type of LED bulbs. In another aspect, one or more of the printed circuit boards 151, 152, 153 is populated with LED bulbs that may differ in type, power rating, efficiency, etc. For example, LEDs with narrow-beam angle lens fitted and/or wide-beam angle may be used. Generally, the narrower the LED beam angle, the further the emitted light may travel before losing its intensity. One skilled in the art would understand that the LED beam angle is a design parameter that is based upon the particular application. An example of an application is for the LED light module to illuminate a street and sidewalk surrounding a street post as shown in FIG. 2. In one example, the street post is approximately 30 feet in height. One of ordinary skill in the art would recognize that the LED light module is not limited to the example of the street post, but may be adapted to other various applications, including indoor illumination.

In one aspect, the LED bulbs are mounted to the printed circuit boards in a perpendicular manner. In another aspect, the LED bulbs are mounted to the printed circuit boards at a non-perpendicular angle. In yet another aspect, some of the LED bulbs are mounted to the printed circuit boards in a perpendicular manner while other LED bulbs are mounted to the printed circuit boards at one or more non-perpendicular angles.

In one aspect, the minimum value of the angle is limited by the physical characteristics of the LED bulbs. For example, the LED bulbs' height dimension will also limit the minimum value of the angle. Accordingly, the LED bulbs can only be angled toward the ground at a certain angle before it physically blocks a nearby LED bulb above or below it. Thus, one skilled in the art would understand that the minimum value of the angle is a design parameter dependent on various factors, such as but not limited to the dimensions of the LED bulbs. In one aspect, the angle is about 45 degrees.

Although the printed boards shown in the LED light module of FIG. 1 are shown to be touching, in one aspect, the printed boards are spaced apart from each other, but keep the angle relation described in the present disclosure. In another example, although the three printed circuit boards are shown as having two of the printed circuit boards 151, 153 being side by side and in front of the third printed circuit board 152, other positioning of the three printed circuit boards may be possible without affecting the scope and spirit of the present disclosure. For example, the three printed circuit boards may be positioned relative to each other such that each one's position is staggered from another printed circuit board. In yet another example, all three printed circuit boards are positioned side-by-side to each other.

For example, the LED bulbs with narrow-beam angle and/or wide-beam angle lenses may be used. An example of an application is for the two-stage LED light module to illuminate a street and sidewalk surrounding a street post as shown in FIG. 2.

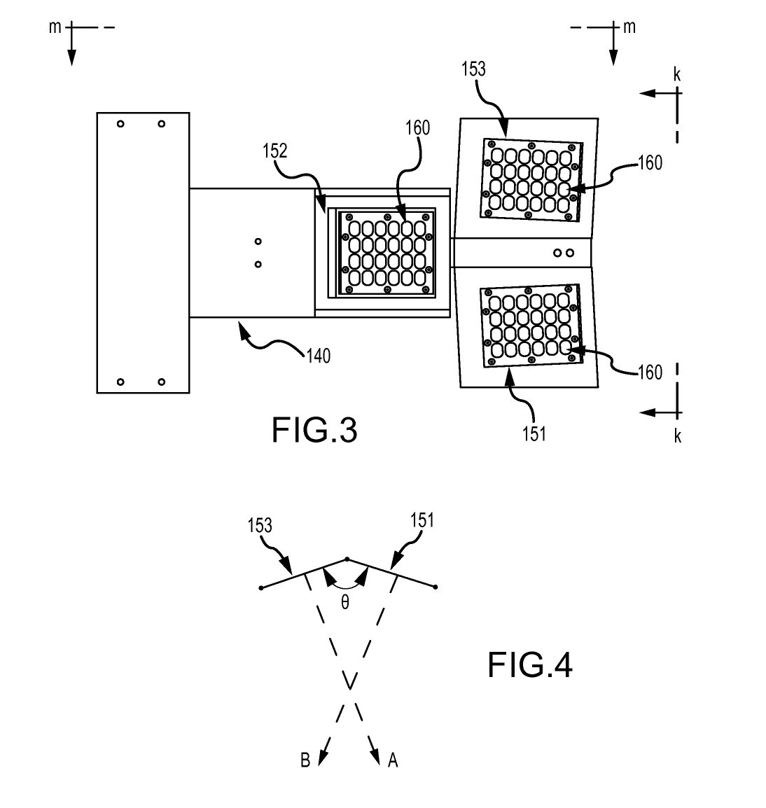

FIG. 3 illustrates an example of the three printed circuit boards 151, 152; 153 and their mounting structure 140. In one example, two of the printed circuit boards 151 & 153 are mounted to form an angle θ which is less than 180 degrees as shown in FIG. 4. In one example, the third of the, printed circuit boards (PCBs) is positioned adjacent to the two of the printed circuit boards (PCBs) as shown in FIG. 3.

FIG. 4 is a top view of the three printed circuit boards of FIG. 3, that is, from the view point of line kk as drawn in FIG. 3. In one example, the angle θ has a value from 110 degrees to 170 degrees. The value of the angle θ may be determined based on application and desired light beam pattern(s). In addition, the value of the angle θ may be chosen to ensure that the light beam patterns are directed towards desired area and to minimize light pollution above a predetermined horizontal line. In one example, the value of the angle θ works in conjunction with the lens 120 to achieve a desired light beam pattern or a direction of illumination.

In one example, the value of the angle θ is chosen such that since PCB 153 is mounted on the left side, it illuminates the right side of the ground as indicated by arrow A. Similarly, since PCB 151 is mounted on the right side, it illuminates the left side of the ground as indicated by arrow B. In one example, two of the printed circuit hoards 151 & 153 are mounted side by side to form a plane (i.e., the angle θ is at 180 degrees). In yet another example, all three printed circuit boards are mounted so that they all aligned with each other in a plane.

Although three printed circuit boards are shown in the example LED light module 150 in FIG. 3, other quantities of printed circuit boards are possible and are within the scope and spirit of the present disclosure. For example, a LED light module may consist of a single printed circuit board to house a plurality of LED bulbs. In another example, a LED light module may consist of two printed circuit board to house a plurality of LED bulbs. In one example, the two printed circuit boards perpendicularly and/or at an angle to the printed are mounted side-by-side to each other in a plane. And, the LED bulbs may be mounted circuit boards so as to direct the light beam emitted by the LED bulbs in one or more directions. In another example, the two printed circuit boards are mounted to form an angle θ which is less than 180 degrees. The value of the angle θ may be determined based on application and desired light beam pattern. Other quantities (i.e., more than three) printed circuit boards may be used in a LED light module without departing from the scope and spirit of the present disclosure.

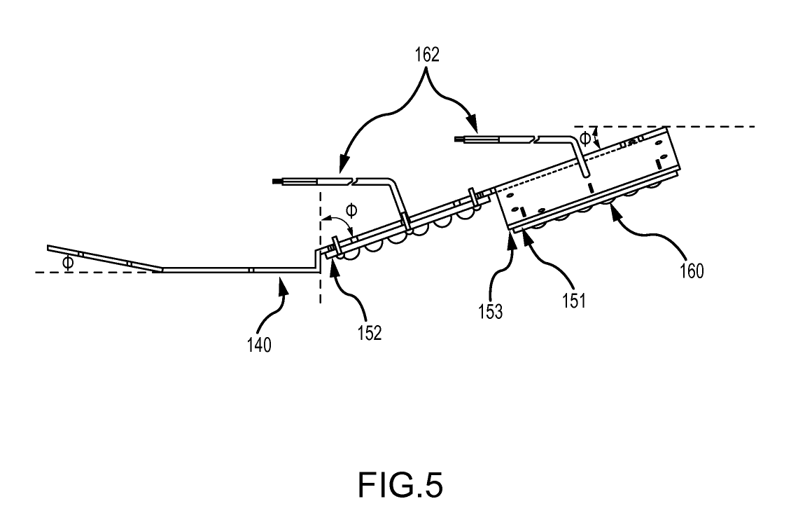

FIG. 5 illustrates a side view of the three printed circuit boards of FIG. 3, that is, from the view point of line mm as drawn in FIG. 3. As shown in the example in FIG. 5, two of the printed circuit boards 151 & 153 are mounted to form an angle θ which is less than 180 degrees. In addition, electrical wires 162 are connected to the printed circuit boards 151, 152, 153 to supply power to the printed circuit boards 151, 152, 153. Although a specific configuration of the mounting structure 140 with respect to how it is angled is shown in FIG. 5, one skilled in the art would understand that other configurations of the mounting structure may be used without affecting the scope and spirit of the present disclosure. In one example, the specific angle formation of the mounting structure 140 is based on the desired direction(s) of the illumination of the LED bulbs 160 mounted on the printed circuit hoards 151, 152, 153. In one example, the various angle formations of the mounting structure may have angle values (φ) between 15 to 45 degrees. Examples of how the angle φ is measured is shown in FIG. 5. One skilled in the art would understand that other angle values (φ) (although not specifically shown) are also within the scope and spirit of the present application.

In one aspect, the printed circuit boards, as described herein, are replaced with non-conductive plates with electrical conductive paths connecting the plurality of LED bulbs to at least one power source.

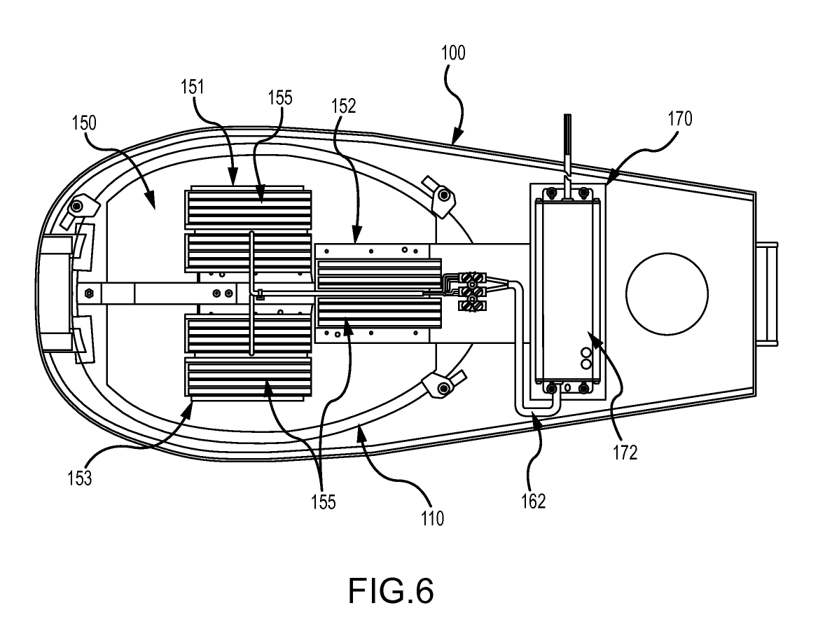

FIG. 6 illustrates a top view of the example LED light module 150 within the housing 100 shown in FIG. 1. As shown in FIG. 6, on the reverse side of the printed circuit boards 151, 152, 153 are heatsink fins 155 for heat dissipation. In one example, the heatsink fins 155 are part of the substrates on which the printed circuit boards 151, 152, 153 reside. Also shown in FIG. 6 is a power supply 172 housed in a power supply compartment 170. In one example, the power supply 172 is an alternating current (AC) power supply. In another example, the power supply 172 is a direct current (DC) power supply. In one application, the LED light module 150 is part of a street post (See FIG. 2) for illuminating a street. In one example, the street post may include solar panels or a battery unit to work in conjunction with the power supply 172 to provide power to the LED bulbs 160.

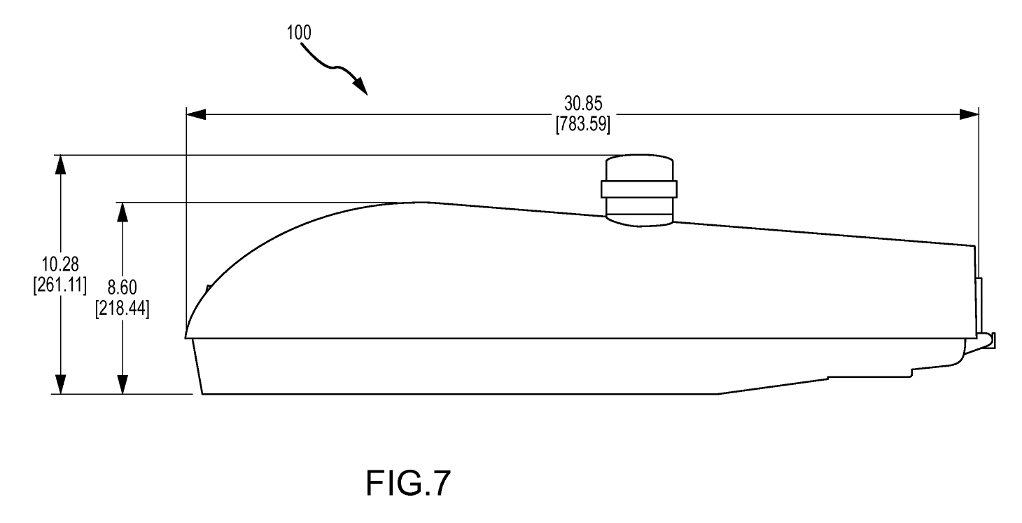

In one aspect, the LED light module 150 is embodied in a housing 100. FIG. 7 illustrates a side view of the housing 100 shown in FIG. 1 for the LED light module 150. Shown in FIG. 7 are example dimensions (in inches) of the housing 100. One skilled in the art would understand the that dimensions shown in FIG. 7 are examples and that other dimensions of the housing 100 may he used and still be within the scope and spirit of the present disclosure.

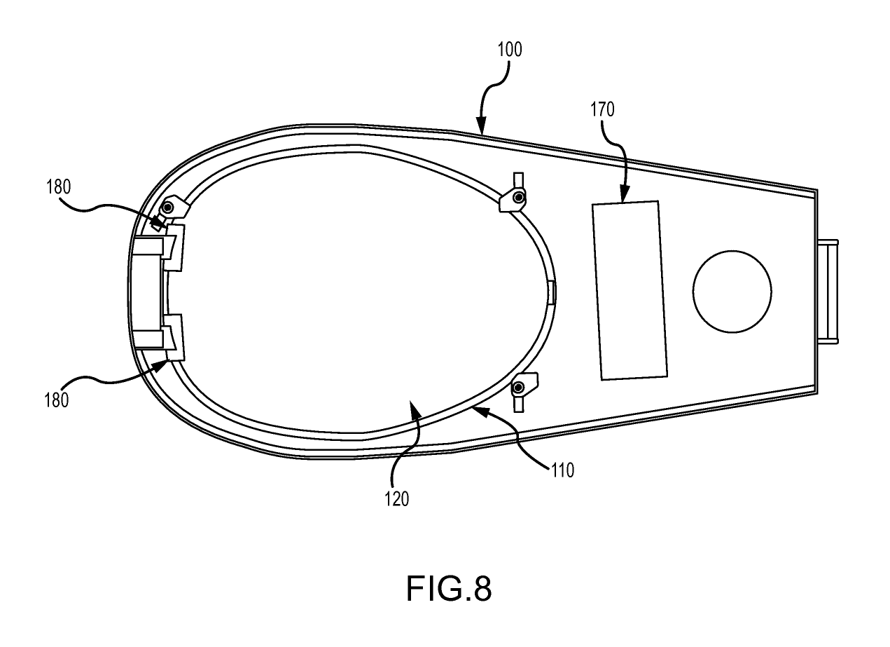

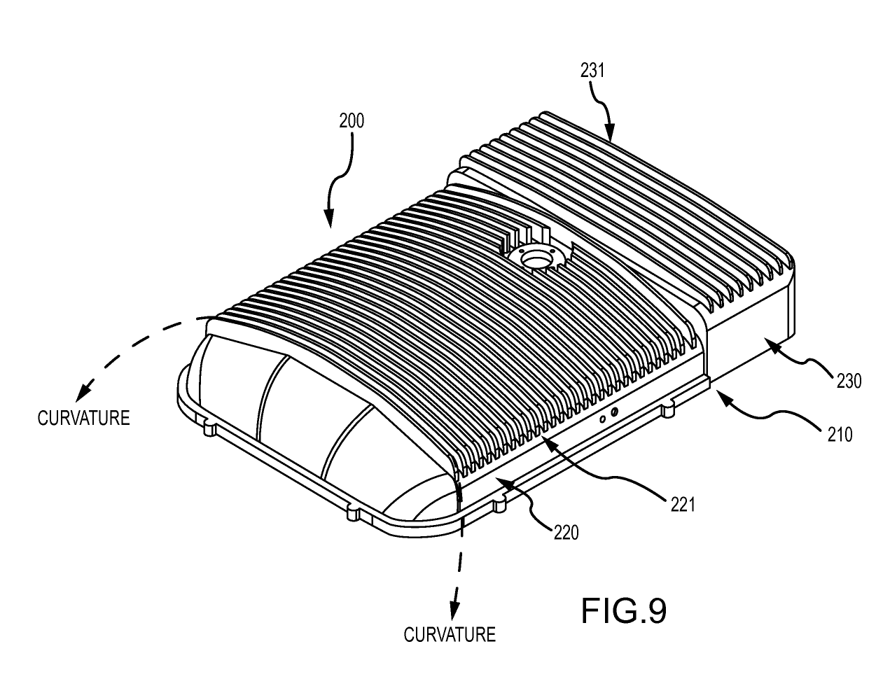

FIG. 8 illustrates a bottom view of the housing 100 shown in FIG. 1 for the LED light module 150. In one example, the housing comprises a power supply compartment 172 for housing a power supply to regulate power to the LED bulbs. In one example, the housing 100 houses a temperature regulation device within the housing to dissipate heat. One skilled in the art would understand that different types of power supplies (such as, but not limited to, constant current or constant voltage types) and different types of temperature regulation devices may be used within the spirit and scope of the present disclosure. In one aspect, the housing includes a cover plate (not shown) covering over the front side of the LED light module. In another aspect, the cover plate is a window 120 (e.g., optical window) which fits over the window opening 110 to allow light from the LED bulbs to shine through.

In one example, gaskets 180 are included in the housing 100. The gaskets 180 act as mechanical seals to fill the space between the mating surfaces of the housing 100 to prevent leakage into the interior of the housing. Although only two gaskets are shown, the quantity of gaskets used in the housing may vary according to design choice or application. In one aspect, the gaskets 180 seals the interior of the housing 100 (e.g., the LED light module 150) from rain, moisture, dust or other contaminations.

In one aspect, the width of the housing (as shown in FIG. 1) is 15 inches, for example, for a streetlight application. However, one skilled in the art would understand that the width and other dimensions of the housing 100 (e.g., as shown in FIG. 7) may vary according to design and application.

In one aspect, the temperature regulation device, for example, may be an air circulation device such as a fan or a heat transfer device such as a heat sink. The temperature regulation device uniformly dissipates heat collected within the housing to reduce local hot spots. Regulating heat dissipation can promote longer life span of the LED bulbs.

FIG. 9 illustrates a perspective view of a top side 210 of a second example housing 200 for housing a LED light module 150. In FIG. 9, the housing 200 includes heatsink fins 221, 231 on its top side 210. In one example, the top side 210 is divided into two sections, a main section 220 and an auxiliary section 230. In one example, the main section 220 houses the LED light module 150 while the auxiliary section 230 houses a power supply (not shown) and/or other electronic units (not shown). In the present example, the heatsink fins 221 are integrated with the main section 220 and the heatsink fins 231 are integrated with the auxiliary section 231. In one example, the main section 220 includes a curvature which allows any water condensation (e.g., from rain or condensed fog/mist) to roll off the left and right side edges of the main section 220. In addition to water condensation, the curvature may minimize gathering of dust on the tope side 210 of the housing 200. One skilled in the art would understand that a specific value of the curvature is a design choice and/or may be dependent on a particular application or use.

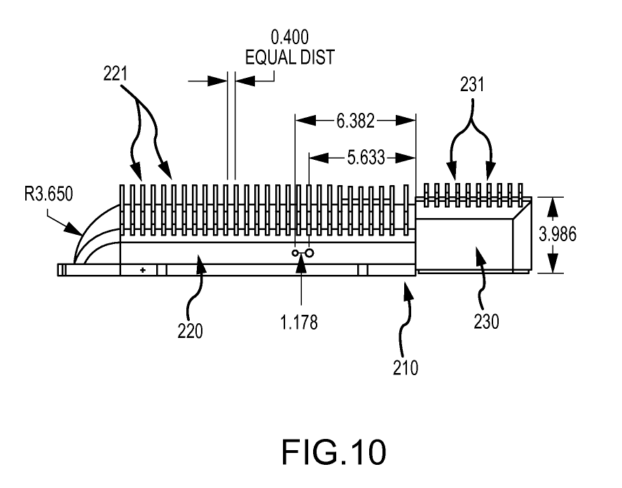

FIG. 10 illustrates a side view of the top side 210 shown in FIG. 9. In FIG. 10, examples of dimensions of the top side 210 are illustrated. The dimensions are in inches. One skilled in the art would understand that although specific dimensions are listed in FIG. 10, these dimensions are examples and do not exclude other dimensional values. In one example, the dimensions of the top side 210 are determined either by design choice or by a particular application or use.

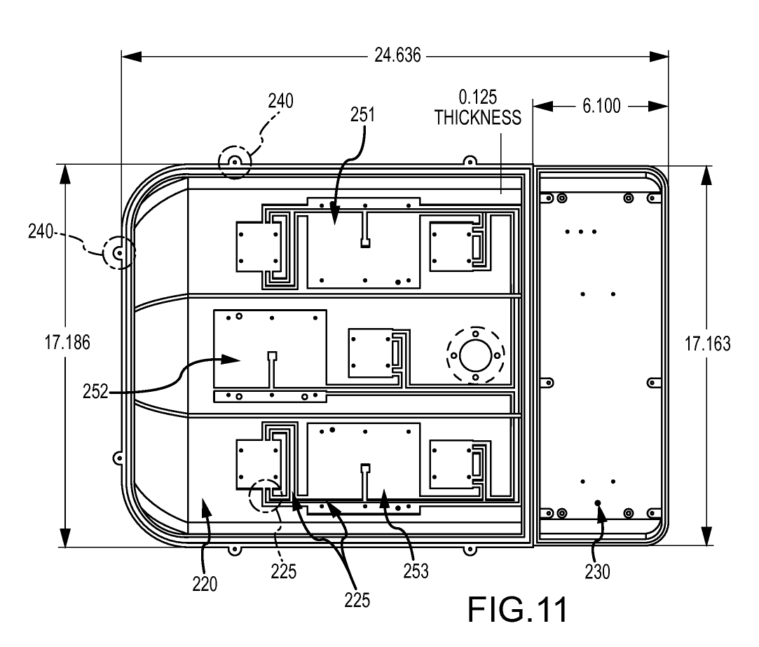

FIG. 11 illustrates a bottom view of the top side 210 shown in FIG. 9. From the bottom view, three printed circuit boards 251, 252, 253 are shown. A plurality of LED bulbs (not shown) may be mounted on each of the three printed circuit boards 251, 252, 253. Also shown are various electrical wiring 225 for connecting the printed circuit boards 251, 252, 253 and its LED bulbs to a power source, for example, a power supply (not shown). Also shown are screw holes 240 for coupling the top side 210 to a bottom side (not shown) of housing 200.

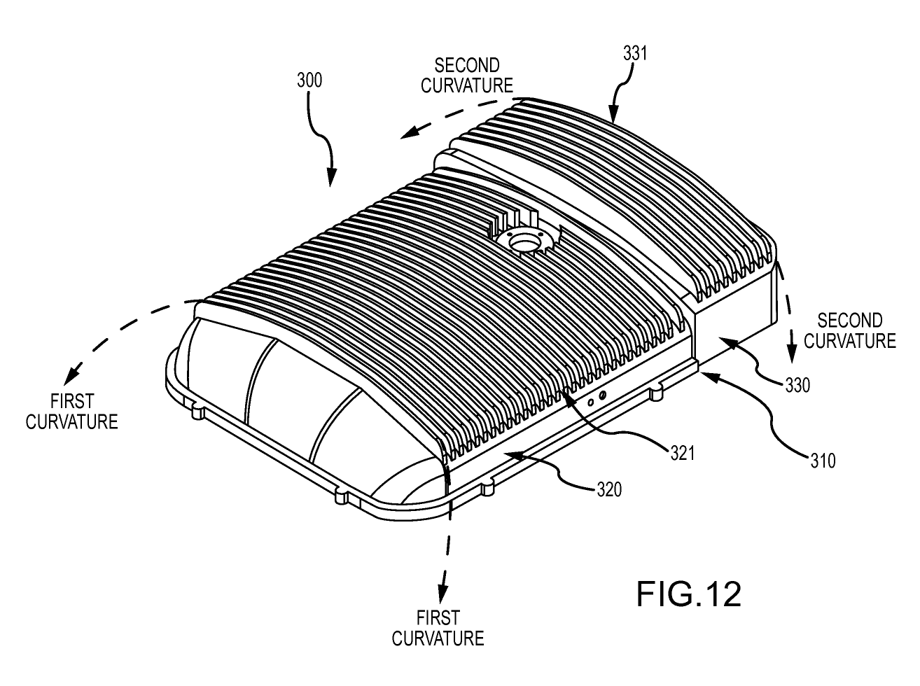

FIG. 12 illustrates a perspective view of a top side 310 of a third example housing 300 for housing a LED light module 150. In one example, the top side 310 is divided into two sections, a main section 320 and an auxiliary section 330. In one example, the main section 320 houses the LED light module 150 while the auxiliary section 330 houses a power supply (not shown) and/or other electronic units (not shown). In the present example, the heatsink fins 321 are integrated with the main section 320 and the heatsink fins 331 are integrated with the auxiliary section 331.

In one example of housing 300, the main section 320 includes a first curvature which allows any water condensation (e.g., from rain, or fog, mist) to roll off the left and right side edges of the main section 320. In one example, the auxiliary section 330 also includes a second curvature to allow water condensation (e.g., from the heat dissipation) to roll off the left and right side edges of the auxiliary section 330. The first curvature and the second curvature may be the same or may be different (i.e., same or different curvature values). One skilled in the art would understand that a specific value of either the first or second curvature is a design choice and/or may be dependent on a particular application or use. In one variation (not shown), the main section 320 does not include a curvature and only the auxiliary section 330 includes a curvature.

Although the curvature(s) shown on the top side of the housings in FIGS. 9 and 10 run from left to right (or right to left), in another example, the curvature(s) can run from front to back (or back to front).

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention.

1. A Light Emitting Diode (LED) light module comprising:
three printed circuit boards (PCBs) positioned relative to each other; and
a plurality of LED bulbs mounted on each of the three printed circuit boards to form a single light source.

2. The LED light module of claim 1, wherein Iwo of the printed circuit boards (PCBs) are positioned relative to each other at an angle, the angle having a value between 110 degrees to 170 degrees.

3. The LED light module of claim 2, wherein the third of the printed circuit boards (PCBs) is positioned adjacent to the two of the printed circuit boards (PCBs).

4. The LED light module of claim 3, further comprising a mounting structure for mounting the three printed circuit boards (PCBs).

5. The LED light module of claim 1, wherein the LED light module is housed within a housing, the housing comprising a window opening and a window fitted to the window opening.

6. The LED light module of claim 5, wherein the window is an aspheric shape

7. The LED light module of claim 5, wherein the housing further comprises a power supply for supplying power to the plurality of LED bulbs.

8. The LED light module of claim 6, wherein the housing fits to a street post for lighting streets and sidewalks.

9. The LED light module of claim 5, wherein the housing includes heatsink fins for heat dissipation on its top side.

10. The LED light module of claim 9, wherein the top side includes two sections, a main section and an auxiliary section.

11. The LED light module of claim 10, wherein the heatsink fins on the main section are arranged in a first curvature.

12. The LED light module of claim 11, wherein the heatsink fins on the auxiliary section are arranged in a second curvature.

13. The LED light module of claim 12, wherein the first curvature and the second curvature differ in value.

14. The LED light module of claim 1, wherein at least one of the three printed circuit boards is coupled to a plurality of heatsink fins for heat dissipation.
